(19) United States
(12) Patent Application Publication
(10) Pub. No.: US 2020/0023337 A1
(43) Pub. Date: Jan. 23, 2020

(54) METHOD FOR ABSORBING LIQUIDS INTO SILICONE-CONTAINING POLYMERS

(71) Applicant: WACKER CHEMIE AG, Munich (DE)

(72) Inventors: Elke Fritz-Langhals, Ottobrunn (DE); Richard Weidner, Burghausen (DE)

(21) Appl. No.: 16/482,388

(22) PCT Filed: Feb. 3, 2017
(86) PCT No.: PCT/EP2017/052431

§ 371 Date: Jul. 31, 2019

(51) Int. Cl. B01J 20/26; C08L 83/06; C08G 77/388; C08G 77/14

(52) U.S. Cl. CPC B01J 20/265; C08L 83/06; C08L 2203/02; C08G 77/14; C08G 77/388

(57) ABSTRACT

The invention relates to a method for absorbing liquids (P) containing compounds (V) selected from water and alkanols, the oxygen content of which in weight percentage is at least 27%, said content being present in the loan of hydroxy groups or hydroxy and ether groups, into a solid silicone-containing polymer (P) which contains at least one siloxane unit of the general formula I (R¹_{b}(X)_{c}SiO_{[4-(b+c)]/2)} and no units or at least one unit of the general formula II (R²ₐSiO_{4-a)/2)}, in which R¹, R², x, a, b, and c have the meanings described in claim 1, wherein the liquids (P) are brought into contact with the solid silicone-containing polymer (P).

The invention relates to a method for absorbing water and water-like compounds into silicone-containing polymers.

The absorption of water is an important technical function. Particularly polymer materials capable of taking up large amounts of water through absorption processes are of quant industrial significance. On contact with water or with water-like liquids, the polymer material generally undergoes an expansion in volume due to absorption of water.

Absorption is defined as the uniform penetration of water or water-like compounds into a solid polymer material, wherein the phase boundary is essentially preserved. In addition, polymeric solids can also undergo adsorptive processes, which is understood to mean the uptake of water or water-like substances at the polymer surface.

Polymer materials with such properties are known. For example, polysaccharides, proteins, polyvinyl alcohols or polyacrylates act as absorbers of water. Examples of applications are the absorption of problematic water in solvents, the absorption of body fluids, for example in sanitary products or in wound dressings. Water-absorbing materials are also used for the self-sealing of structural elements exposed to the weather. The expansion in volume brought about by contact with water allows cracks to be sealed.

The examples given demonstrate the technological importance of the absorption of aqueous liquids.

However, there have to date been only few polymeric materials that can be used for the process of water absorption. Among synthetically obtainable polymers, it is almost exclusively water absorbers based on polyacrylic acid or polyacrylates that are used. A disadvantage of these polymers is, for example, that, prior to absorption of water, they are present as powders and are consequently more difficult to process. Often it is necessary to employ additional granulation, subsequent cross-linking, and coating steps in order to bind the fines inevitably present.

What would therefore be desirable are water-absorbing, silicone-based polymers that are non-crystalline and mostly plastically deformable and which accordingly provide handling advantages over the prior art. A further advantage of silicones as the basis for polymers is that they are chemically extremely inert and have good oxygen permeability.

The object of the present invention is to provide a method for absorbing water-containing liquids that does not have the stated disadvantages of the prior art.

The invention relates to a method for absorbing liquids (L) that contain compounds (C) selected from water and alkanols with a proportion by weight of oxygen, present in the form of hydroxy or hydroxy and ether groups, of not less than 27%, into solid, silicone-containing polymers (P) that contain at least one siloxane unit of general formula I and no or at least one unit of general formula II

R¹_{b}(X)_{c}SiO_{4-(b+c)]/2} (I),

R²ₐSiO_{(4-a)/2} (II),

in which
R¹ and R² are independently hydrogen or an unbranched, branched or cyclic saturated or unsaturated alkyl group with 1 to 20 C atoms or aryl group or aralkyl group, wherein individual non-adjacent methylene units may be replaced by —O—, —CO—, —COO—, —OCO— or —OCOO—, —S— or NR^{x} groups or by an oxyalkylene group of general formula (—O—CH₂—CHR³—)_{d},
R₃ is hydrogen or alkyl,
R^{x} is hydrogen or a C₁-C₁₀ hydrocarbon residue that is unsubstituted or substituted with substituents selected from —CN and halogen,
X is a residue bearing at least one amino acid unit and linked to the silicon atom through a carbon atom, having the general formula

—Y—NR⁴—(CH₂)ₑ—CR⁵R⁶—COOM,
M is hydrogen, metal or an ammonium residue NR¹⁰₄⁺,
R¹⁰ is independently hydrogen or C₁-C₁₂ alkyl, aryl or aralkyl,
R⁴ is hydrogen or a linear, branched or cyclic saturated or unsaturated alkyl group with 1 to 20 C atoms or aryl group or aralkyl group, wherein individual non-adjacent methylene units may be replaced by —O—, —CO—, —COO—, —OCO— or —OCOO—, —S— or NR^{x} groups or by an oxyalkylene group of general formula (—O—CH₂—CHR³—)_{d},
R⁵ and R⁶ are independently hydrogen or linear, branched or cyclic saturated or unsaturated alkyl groups with 1 to 20 C atoms or aryl groups or aralkyl groups, wherein individual non-adjacent methylene units may be replaced by —O—, —CO—, —COO—, —OCO—, or —OCOO—, —S— or NR^{x} groups, where R⁵ or R⁶ may be linked to R⁴ ,
Y is a linear, branched, cyclic, saturated or mono- or polyunsaturated C₁ to C₁₀₀ alkylene residue linked to the organosilicon compound through a carbon atom, in which individual carbon atoms may be replaced by oxygen, nitrogen or sulfur atoms and which may be substituted with non-adjacent hydroxyl groups,

a has the values 0, 1, 2 or 3,

b has the values 0, 1 or 2,

c has the values 1, 2 or 3

d has integer values from 1 to 100,

b+c has the values 1, 2, 3 or 4, and

e has integer values 0 to 50,

in which the liquids (L) are brought into contact with the solid, silicone-containing polymer (P).

Silicones are known to be extremely hydrophobic polymer materials. However, it has been surprisingly been found that the absorption of water and alkanols with a content by weight of oxygen, present in the form of hydroxy or hydroxy and ether groups, of not less than 27% can be advantageously executed, particularly from water-containing liquids, using silicone-containing polymers (P) that contain amino acid moieties.

For the purposes of the invention, absorption is defined as the uniform penetration of liquids (L) into the solid, silicone-containing polymer (P), wherein the phase boundary between liquids (L) and silicone-containing polymer (P) is preserved.

The amino acid moieties —Y—NR⁴—(CH₂)ₑ—CR⁵R⁶—COOM may be present in various protonation states. Carboxylic acid moieties may be present as the free carboxylic acid or as the carboxylate salt or as a mixture of the two. The amino acid moiety may be present either as the free amino acid group or in protonated form as an ammonium moiety or as a mixture of the two.

R¹ and R² are preferably independently hydrogen or an unbranched, branched or cyclic saturated or unsaturated alkyl group with 1 to 6 C atoms or a benzyl or phenyl group, wherein non-adjacent methylene units may be replaced by nitrogen atoms or oxygen atoms or by an oxyalkylene group of general formula (—O—CH₂—CHR³—)_{d}. The residues R³ here are preferably hydrogen or methyl, especially preferably methyl.

R^{x} is preferably hydrogen or an unsubstituted C₁-C₆ hydrocarbon residue.

M is preferably an alkali metal or alkaline earth metal, more preferably alkali metal, especially preferably sodium or potassium, or an ammonium residue.

R¹⁰ is preferably hydrogen or C₁-C₄ alkyl, especially preferably methyl, ethyl, n-propyl.

R⁴ preferably hydrogen or a linear, branched or cyclic saturated or unsaturated alkyl group with 1 to 10 C atoms or a benzyl or phenyl group, wherein non-adjacent methylene units may be replaced by nitrogen atoms or oxygen atoms or by an oxyalkylene group of general formula (—O—CH₂—CHR³—)_{d}. R⁴ is more preferably a C₁-C₆ alkyl group in which methylene units may be replaced by oxyalkylene groups of general formula —O—(CH₂—CHR³—)_{d}, especially methyl. The residues R³ here are preferably hydrogen or methyl, especially methyl.

Preferably, R⁵ is hydrogen and R⁶ is hydrogen or a linear, branched or cyclic saturated or unsaturated alkyl group with 1 to 10 C atoms or aryl group or aralkyl group, wherein individual non-adjacent methylene units may be replaced by —O—, —CO—, —COO—, —OCO— or —OCOO—, —S— or NR^{x} groups.

In particular, R⁴ is hydrogen and R⁶ is —CH₂—CH₂—CH₂—CH₂—NH₂, —CH₂—CH₂CH₂—NH₂, —CH₂—CH₂—CH₂—NH—C(═NH)—NH₂, and —CH₂—(4-imidazolyl), —CH₂—(3-indolyl).

If R⁴ is linked to R⁵ or to R⁶, then the residues are preferably linked through an alkylene residue, especially with 1 to 6 carbon atoms.

Y is preferably a linear or branched, saturated C₁ to C₂₀ alkylene residue in which individual carbon atoms may be replaced by oxygen, nitrogen or sulfur atoms.

Y is more preferably a (Z)ₑ—CR⁷(OH)—CR⁸R⁹ moiety.

Z is a linear, branched, cyclic, saturated or mono- or poly-unsaturated C₁ to C₁₀₀ alkylene residue linked to the organosilicon compound through a carbon atom, in which individual carbon atoms may be replaced by oxygen atoms. Z is more preferably an oxyalkylene residue of general formula —CH₂—CH₂—CH₂—O—(CH₂—CHR¹¹—O)_{f}—CH₂ in which the residues R¹¹ are independently hydrogen or alkyl, especially preferably methyl, and f assumes a value from 0 to 100, preferably 0 to 50 and more preferably 0.

The residues R⁷, R⁸, and R⁹ are preferably independently hydrogen or a linear C₁ to C₆ alkyl group, more preferably hydrogen or linear C₁ to C₃ alkyl group. The residues R⁸ and R⁹ may also be linked to one another and to the moiety Z through alkylene residues or oxygen.

d and f are preferably in each case independently 0 to 50 more preferably 0 to 10, especially preferably 0 to 5, and most preferably the values 0 to 3.

e is preferably 0 to 10, especially preferably 0 to 5, and most preferably 0 to 3.

The above-described silicone polymers (P) used for absorbing liquids (L) can be prepared in a manner known to those skilled in the art. Attachment of the amino acids can for example be achieved by the following reactions:

(a) addition of the amino groups in amino acids onto epoxy-functionalized siloxanes,

(b) addition of amino acids containing thiol groups onto vinyl siloxanes,

(c) nucleophilic substitution of chloroalkyl-functional siloxanes with the amino group of amino acids

(d) reaction of anhydride-functional siloxanes with amino acids.

The coupling mode is preferably as stated in (a), in which the amino group of the amino acid undergoes addition onto an epoxide moiety present in the silicone polymer. A double addition can also take place here, i.e. two silicone residues can be attached per amino group present. If an amino acid contains more than one basic nitrogen-containing group, these can react in the same way, which means that a maximum of 2 silicone residues in total can be attached per amino group present.

The arrangement of the siloxane and amino acid units with respect to one another can vary here. Examples of this are shown below, taking lysine as an example:

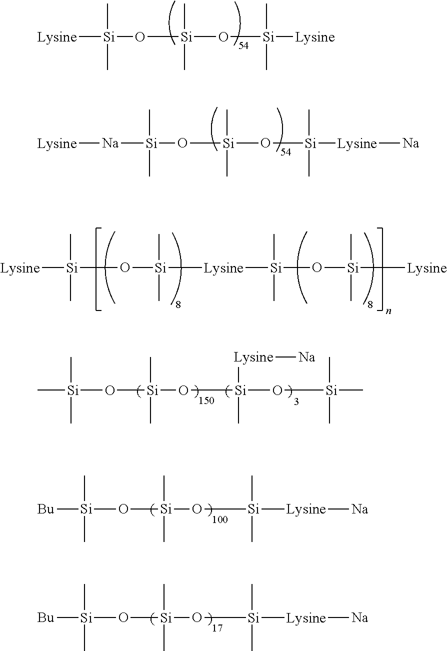

The silicone-containing polymers (P) used for absorbing liquids (L) may contain further polymers. These may form homogeneous or inhomogeneous mixtures, they may be linked to the polymer (P) covalently or through hydrogen bonds or they may also be unlinked. The silicone-containing polymers (P) contain these further polymers preferably in contents of not less than 1 and not more than 95 parts by weight, more preferably in proportions of not less than 5 and not more than 80 parts by weight, and especially in not less than 10 and not more than 50 parts by weight per 100 parts by weight of siloxane units of general formula I and II.

The silicone-containing polymer (P) may contain blocks of siloxane units of general formula I and no or at least one unit of general formula II and organic blocks interspersed in the blocks of siloxane units. The organic blocks may be linked to the blocks made up of siloxane units, for example through urea moieties, urethane moieties or ester groups. The proportion of organic blocks is preferably not less than 2 and not more than 300 parts by weight, more preferably not more than 30 parts by weight, and especially preferably not more than 10 parts by weight per 100 parts by weight of siloxane units of general formula I and II.

The polymers (P) used for absorbing liquids (L) may or may not be cross-linked.

The polymers (P) may contain other substances present as solids or in dissolved form.

The solids used may be, for example, fillers, for example colloidal silica, silicates, zeolites or carbon-based fillers, for example carbon black.

The liquid (L) contains as compound (C) preferably water and alkanol with 1 to 3 carbon atoms, preferably methanol and ethanol, glycerol, ethylene glycol, diethylene glycol, triethylene glycol, ethylene glycol monomethyl ether, ethylene glycol dimethyl ether, ethylene glycol monoethyl ether, ethylene glycol diethyl ether, diethylene glycol diethyl ether or diethylene glycol dimethyl ether and mixtures thereof, especially water.

The liquid (L) contains preferably not less than 80% by weight, more preferably not less than 90% by weight, and especially not less than 97% by weight of compound (C).

The liquid (L) is preferably monophasic or biphasic. It preferably contains water in proportions of not less than 0.1% and not more than 100% by weight, preferably not less than 1% and not more than 99% by weight and more preferably not less than 10% and not more than 90% by weight.

Other components that may be present in the liquid (L) are inorganic and organic salts, for example NaCl, ammonium chloride, potassium chloride in proportions of preferably not less than 0.01% and not more than 30% by weight, more preferably not less than 0.1% and not more than 10% by weight, and especially preferably not less than 1% and not more than 5% by weight. Other components that may be present are organic compounds, for example water-soluble, water-insoluble or partly water-soluble organic solvents, which may be of low molecular weight or polymeric, or organic solids, for example amino acids, urea, sugars, oligo- and polysaccharides, peptides and proteins.

The liquid (L) preferably contains salt, an organic solvent or is a physiological body fluid, for example blood, urine, sweat or wound exudate.

The silicone-containing polymer (P) can be used for the method for absorbing liquids (L), for example as an amorphous deformable solid or in soaked form, e.g. as a gel.

The absorption of liquids (L) is achieved for example by directly bringing the polymer (P) into contact with the liquid (L) or indirectly via the gas phase.

Between the polymer (P) and the liquid (L) there may be further layers through which the transport of liquid (L) either in liquid or gaseous form is enabled. The transport of liquid (L) through these layers can take place through pores or through channels.

The absorption of liquids (L) can where necessary be promoted by stirring or shaking. The absorption can also take place continuously, by guiding the liquids (L) across the polymer (P).

The absorption of liquids (L) takes place preferably over periods of not less than 1 s and not more than 5 years, more preferably over periods of not less than 1 min and not more than 1 year, and most preferably over periods of not less than 10 min and not more than 4 months.

The absorption of liquids (L) takes place at temperatures of not less than −20° C. and not more than −200° C., more preferably not less than 0° C. and not more than 100° C., and most preferably not less than −10° C. and +50° C.

The absorption of liquids (L) is carried out at a pressure preferably between not less than 0.1 mbar and not more than 50 bar, more preferably not less than 100 mbar and not more than 20 bar, and especially preferably not less than 0.9 bar and not more than 10 bar.

Preferred applications of the method for absorbing liquids (L) are as follows:

for the removal of liquids (L), especially water or liquids containing water, e.g. from organic liquids, e.g. from brake fluids or from mineral oil tanks, for the removal of condensates, for the removal of body fluids, e.g. wound exudate, blood, urine or sweat.

for the self-sealing of structural elements that come into contact with liquids (L), especially water.

The absorption of liquids (L) can be controlled in this method through pH or also electrically.

In the examples which follow, unless otherwise specified, all quantities and percentages are based on weight and all temperatures are 20° C.

The meanings of all the above symbols in the above formulas are each independent of one another. In all formulas the silicon atom is tetravalent.

### EXAMPLE 1

3.04 g of a lysine-modified polymer with the structure

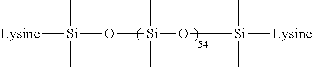

was immersed in water. The increase in weight of the polymer material was determined as a function of the storage time. For this purpose, the polymer in each case was filtered off and water adhering to the surface was blown off in an air stream. Table 1 shows the increase in weight due to absorption of water and the factor of the increase in weight in each case. After 12 days the original weight had increased by a factor of about 10.

TABLE 1
Increase in weight of the lysine-modified polymer
sample from example 1 on contact with water

| | | Factor of increase |
|---|---|---|
| Time (days) | Weight (g) | in weight |
| 0 | 3.04 | 1 |
| 1 | 10.5 | 3.5 |
| 2 | 15.5 | 5.1 |
| 5 | 24.0 | 7.9 |
| 12 | 31.1 | 10.2 |

### EXAMPLE 2

3.03 g of a lysine-modified polymer with the structure

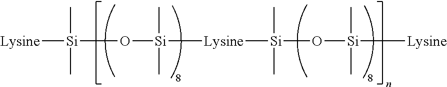

was immersed in water. The increase in weight of the polymer material was determined as a function of the storage time. For this purpose, the polymer in each case was filtered off and water adhering to the surface was blown off in an air stream. Table 2 shows the increase in weight due to absorption and the factor of the increase in weight in each case. After 12 days the original weight had increased by a factor of about 3.

TABLE 2
Increase in weight of the lysine-modified polymer
sample from example 2 on contact with water

| | | Factor of increase |
|---|---|---|
| Time (days) | Weight (g) | in weight |
| 0 | 3.08 | 1 |
| 1 | 5.14 | 1.7 |
| 2 | 5.29 | 1.7 |
| 6 | 7.16 | 2.3 |
| 13 | 9.96 | 3.2 |

### EXAMPLE 3

A polymer film was produced from the lysine-modified polymer with the structure

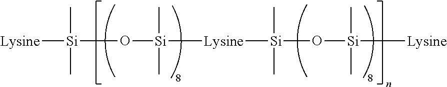

by dissolving the material in ethanol and evaporating off the solvent in a mold. The polymer film was mounted on a microscope slide and this was immersed in water. The increase in weight of the polymer material was determined as a function of the storage time. For this purpose, the polymer in each case was filtered off and water adhering to the surface was blown off in an air stream, and the increase in weight was determined. Table 3 shows the increase in weight due to absorption and the factor of the increase in weight in each case. After 21 days the original weight had increased by a factor of more than four.

TABLE 3
Increase in weight of the lysine-modified polymer
film from example 3 on contact with water

| | | Factor of increase |
|---|---|---|
| Time (days) | Weight (mg) | in weight |
| 0 | 422 | 1 |
| 2 | 771 | 1.8 |
| 4 | 922 | 2.2 |
| 8 | 1173 | 2.8 |
| 21 | 1856 | 4.4 |

1. A method for absorbing liquids (L) comprising:
contacting the liquids (L) with solid, silicone-containing polymers (P), wherein the solid, silicone-containing polymers (P) contain at least one siloxane unit of general formula I and optionally at least one unit of general formula II
R¹_{b}(X)_{c}SiO_{[4-(b+c)]/2} (I).
R²ₐSiO_{(4-a)/2} (II),
in which
R¹ and R² are independently hydrogen or an unbranched, branched or cyclic saturated or unsaturated alkyl group with 1 to 20 C atoms or aryl group or aralkyl group, wherein individual non-adjacent methylene units may be replaced by —O—, —CO—. —COO—, —OCO— or —OCOO—, —S— or NR^{x} groups or by an oxyalkylene group of general formula (—O—CH₂—CHR³—)_{d},
R³ is hydrogen or alkyl.
R^{x} is hydrogen or a C₁-C₁₀ hydrocarbon residue that is unsubstituted or substituted with substituents selected from —CN and halogen,
X is a residue bearing at least one amino acid unit and linked to the silicon atom through a carbon atom, having the general formula
—Y—NR⁴—(CH₂)ₑ—CR⁵ R⁶COOM,
M is hydrogen, metal, or an ammonium residue NR¹⁰ ₄⁺.
R¹⁰ is independently hydrogen or C₁-C₁₂ alkyl, aryl or aralkyl,
R⁴ is hydrogen or a linear, branched or cyclic saturated or unsaturated alkyl group with 1 to 20 C atoms or aryl group or aralkyl group, wherein individual non-adjacent methylene unite may be replaced by —O—, —CO—, —COO—. —OCO— or —OCOO—, —S— or NR^{x} groups or by an oxyalkylene group of general formula (—O—CH₂—CHR³—)_{d},
R⁵ and R⁶ are independently hydrogen or linear, branched or cyclic saturated or unsaturated alkyl groups with 1 to 20 C atoms or aryl groups or aralkyl groups, wherein individual non-adjacent methylene units may be replaced by —O—, —CO—, —COO—, —OCO— or —OCOO—, —S— or NR^{x} groups, where R⁵ or R⁶ may be linked lo R⁴,
Y is a linear, branched, cyclic, saturated or mono- or polyunsaturated C₁ to C₁₀₀ alkylene residue linked to the organosilicon compound through a carbon atom, in which individual carbon atoms may be replaced by oxygen, nitrogen or sulfur atoms and which may be substituted with non-adjacent hydroxyl groups,
a has the values 0,1, 2 or 3,
b has the value 0, 1 in 2,
c has the values 1, 2 or 3,
d has integer values from 1 to 100,
b+c has the values 1, 2, 3 or 4, and
e has integer values 0 to 50,
wherein the liquids (L) include compounds (C) selected front water and alkanols with a proportion by weight of oxygen, present in the form of hydroxy or hydroxy and ether groups, of no less that 27%.

2. The method of claim 1, R¹ and R² are independently an unbranched, branched or cyclic saturated or unsaturated alkyl group with 1 to 6 C atoms.

3. The method of claim 1, wherein M is selected from sodium, potassium, and ammonium residue.

4. The method of claim 1, wherein e is values from 0 to 5.

5. The method of claim 1, wherein the silicone-containing polymers (P) used for absorbing liquids (L) contain further polymers.

6. The method of claim 1, wherein the compounds (C) are selected from the group consisting of water, methanol, ethanol, glycerol, ethylene glycol, diethylene glycol, triethylene glycol, ethylene glycol monomethyl ether, ethylene glycol dimethyl ether, ethylene glycol monoethyl ether, ethylene glycol diethyl ether, diethylene glycol diethyl ether or diethylene glycol dimethyl ether and mixtures thereof.

7. The method of claim 1, wherein the liquid (L) contains at least 80% by weight of compound (C).

8. (canceled)

9. (canceled)

10. (canceled)

11. The method of claim 1, wherein the liquid (L) is an organic fluid.

12. The method of claim 11, wherein the liquid (L) is brake fluids.

13. The method of claim 11, wherein the liquid (L) is from mineral oil tanks,

14. The method of claim 1, wherein the liquid (L) is bodily fluids.

15. The method of claim 1, wherein the solid, silicone-containing polymers (P) is self-sealing when absorbing the liquid (L).
